(19) United States
(12) Patent Application Publication
(10) Pub. No.: US 2025/0138132 A1
(43) Pub. Date: May 1, 2025

(54) RADIO RESOURCE CONTROL (RRC) USER EQUIPMENT (UE) ASSISTANCE INFORMATION (UAI) MESSAGE INCLUDING POSITIONING ASSISTANCE DATA

(71) Applicant: QUALCOMM Incorporated, San Diego, CA (US)

(72) Inventors: Alexandros Manolakos, Athens (GR); Srinivas Yerramalli, San Diego, CA (US); Mukesh Kumar, Hyderabad (IN)

(21) Appl. No.: 18/691,347

(22) PCT Filed: Oct. 20, 2022
(86) PCT No.: PCT/US2022/078438

§ 371 Date: Mar. 12, 2024

(30) Foreign Application Priority Data
Nov. 18, 2021 (GR) 20210100807

(51) Int. Cl. G01S 5/02; H04W 64/00

(52) U.S. Cl. CPC G01S 5/0236; H04W 64/003

(57) ABSTRACT

This disclosure provides systems, methods, and devices for wireless communication that supports an assistance indicator, such as a UAI message, that includes position assistance information. In a first aspect, a method of wireless communication includes generating, by a user equipment (UE), an assistance indicator including position assistance information. The method further includes transmitting the assistance indicator to a network entity. Other aspects and features are also claimed and described.

### CROSS-REFERENCE TO RELATED APPLICATIONS

This application claims the benefit of Greek Patent Application No. 20210100807, entitled, “RADIO RESOURCE CONTROL (RRC) USER EQUIPMENT (UE) ASSISTANCE INFORMATION (UAI) MESSAGE INCLUDING POSITIONING ASSISTANCE DATA,” filed on Nov. 18, 2021, which is expressly incorporated by reference herein in its entirety.

### TECHNICAL FIELD

Aspects of the present disclosure relate generally to wireless communication systems, and more particularly, to a user equipment (UE) assistance information (UAI) message, such as a UAI message that includes positioning assistance data. Some features may enable and provide improved communications, including implement a corrective action to reduce or resolve a detected trigger condition at the UE.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

With the introduction of 5^{th} Generation (5G) or new radio (NR) networks (sometimes referred to as “5G NR” networks/systems/devices), UEs are able to have higher capability, higher data rate, higher bandwidth. Additionally, UEs are also able to operate in a variety of architectures that provide dual connectivity. As devices continue to improve and “do more”, overheating and other operational issues become a concern for continued operation of a device and for a positive user experience. For example, when a device overheats, the overheating can damage one or more components and negatively impact the user experience.

Solutions that address overheating while still providing communication services have been proposed and implemented for long term evolution (LTE) and for NR in which a UE interacts with the network to implement a corrective action to reduce an overheating condition at the UE. However, corrective actions are limited to those options defined or included in Rel. 15, such as UEAssistanceInformation-v1540-IEs, and Rel. 16, such as UEAssistanceInformation-v1610-IEs.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes generating, by a user equipment (UE), an assistance indicator including position assistance information. The method further includes transmitting the assistance indicator to a network entity.

In an additional aspect of the disclosure, an apparatus includes at least one processor and a memory coupled to the at least one processor. The at least one processor is configured to generate an assistance indicator including position assistance information, and initiate transmission of the assistance indicator to a network entity.

In an additional aspect of the disclosure, an apparatus includes means for generating an assistance indicator including position assistance information. The apparatus further includes means for transmitting the assistance indicator to a network entity.

In an additional aspect of the disclosure, a non-transitory computer-readable medium stores instructions that, when executed by a processor, cause the processor to perform operations. The operations include generating an assistance indicator including position assistance information, and initiating transmission of the assistance indicator to a network entity.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports an assistance indicator that includes position assistance information according to one or more aspects.

FIG. 4 is a ladder diagram illustrating an examples of assistance indicator signaling that includes position assistance information according to one or more aspects.

FIG. 5 is a ladder diagram illustrating an examples of assistance indicator signaling that includes position assistance information according to one or more aspects.

FIG. 6 is a ladder diagram illustrating an examples of assistance indicator signaling that includes position assistance information according to one or more aspects.

FIG. 7 is a flow diagram illustrating an example process that supports an assistance indicator that includes position assistance information according to one or more aspects.

FIG. 8 is a block diagram of an example UE that supports an assistance indicator that includes position assistance information according to one or more aspects.

FIG. 9 is a flow diagram illustrating an example process that supports an assistance indicator that includes position assistance information according to one or more aspects.

FIG. 10 is a block diagram of an example base station that supports an assistance indicator that includes position assistance information according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that supports an assistance indicator, such as a user equipment (UE) assistance information (UAI) message, that includes position assistance information. A UE may be configured to generate an assistance indicator including position assistance information. The assistance indicator may include or correspond to a UAI message, such as an RRC UAI message, and the position assistance information may include or correspond to position assistance data. The position assistance information may include or indicate one or more settings or options to adjust a positioning capability of the UE. In some implementations, the assistance indicator may have a UAI structure and may be associated with or include an information element having a format “PositionAssistanceInfo: (Optional)”. The UE may transmit the assistance indicator to a base station, a core network, a Location Management Function (LMF), or a combination thereof. The assistance indicator may indicate to the network that that the UE would like to have a temporary change in the UE position preferences. In some implementations, the UE may inform the network and request a temporary change such that that the network can determine the best way to implement change. In other implementations, the UE may inform the network of the change it intends to implement and may implement the change with or without network input.

Particular implementations of the subject matter described in this disclosure may be implemented to realize one or more of the following potential advantages or benefits. In some aspects, the present disclosure provides techniques that supports an assistance indicator, such as a UAI message, that includes position assistance information. The assistance indicator may enable the UE to temporality operate at a reduced capability, such as a reduced positioning capability, based on or in response to a detected trigger condition. Adjusting a positioning capability of the UE provide the UE with additional flexibility and adjustment options in view of conventional approaches to adjust data processing capabilities, also referred to as UE capabilities, of the UE. Accordingly, the assistance indicator enables the UE to have improved operations to dynamically address the detected trigger condition, reduce damage and interruptions, and thereby improve a user experience.

In various implementations, the techniques and apparatus described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

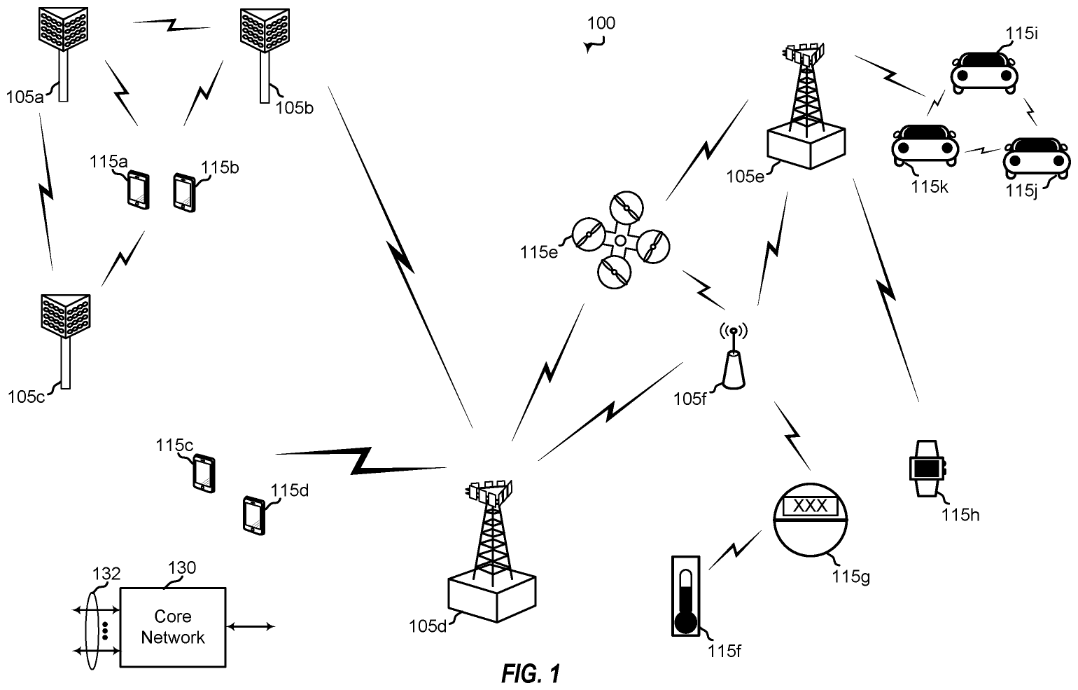

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a Location Management Function (LMF), which is an entity in the 5G Core Network (5GC) supporting various functionality, such as managing support for different location services for one or more UEs. For example the LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115. In some implementations, UE 115 and base station 105 are configured to communicate with the LMF via an Access and Mobility Management Function (AMF).

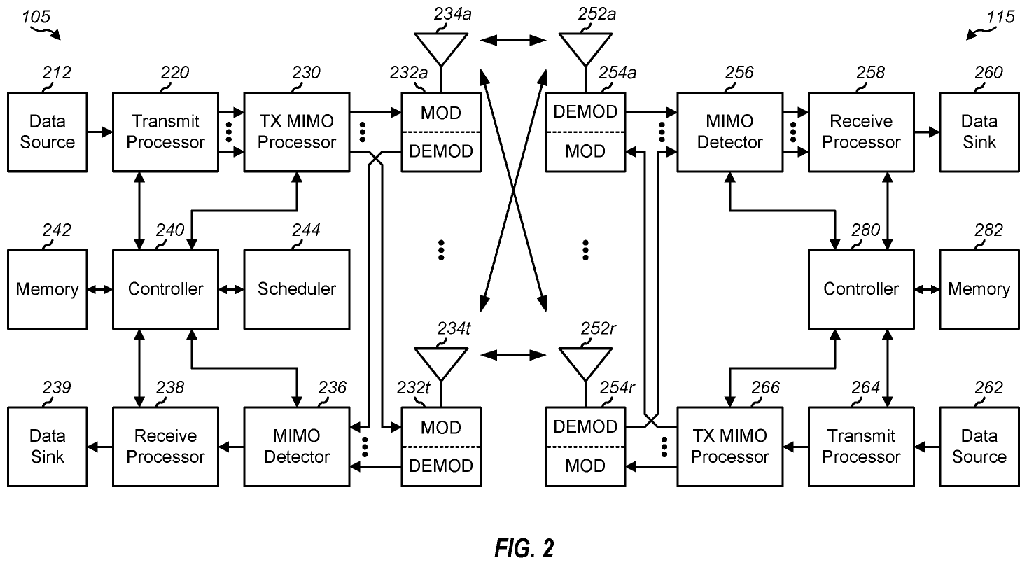

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

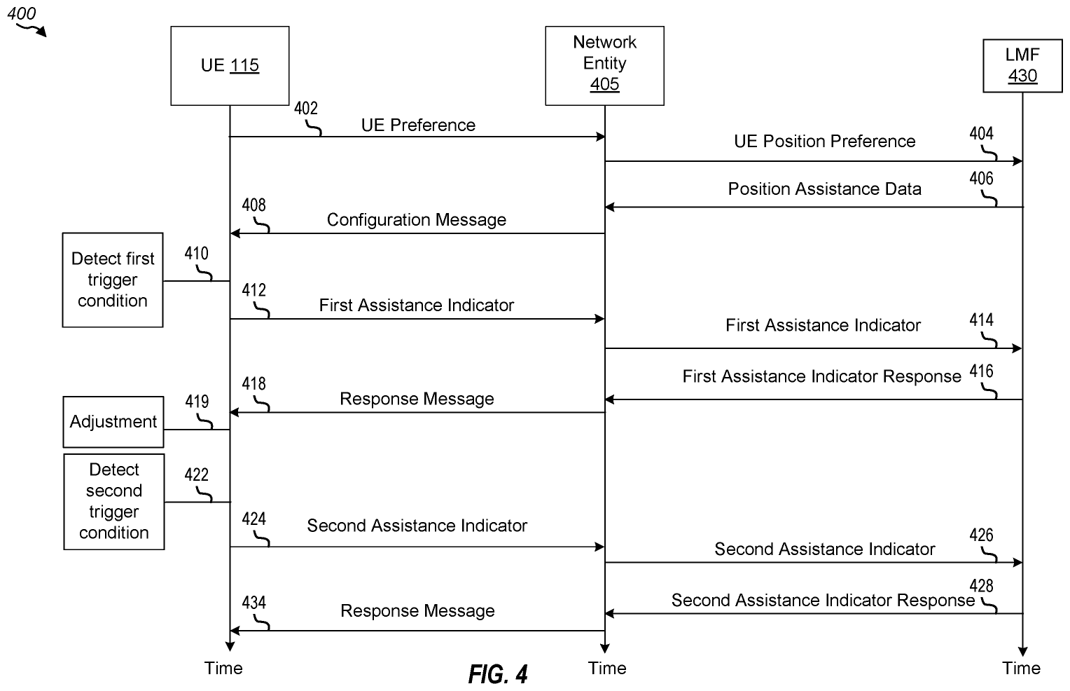

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 4-7 or 9, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

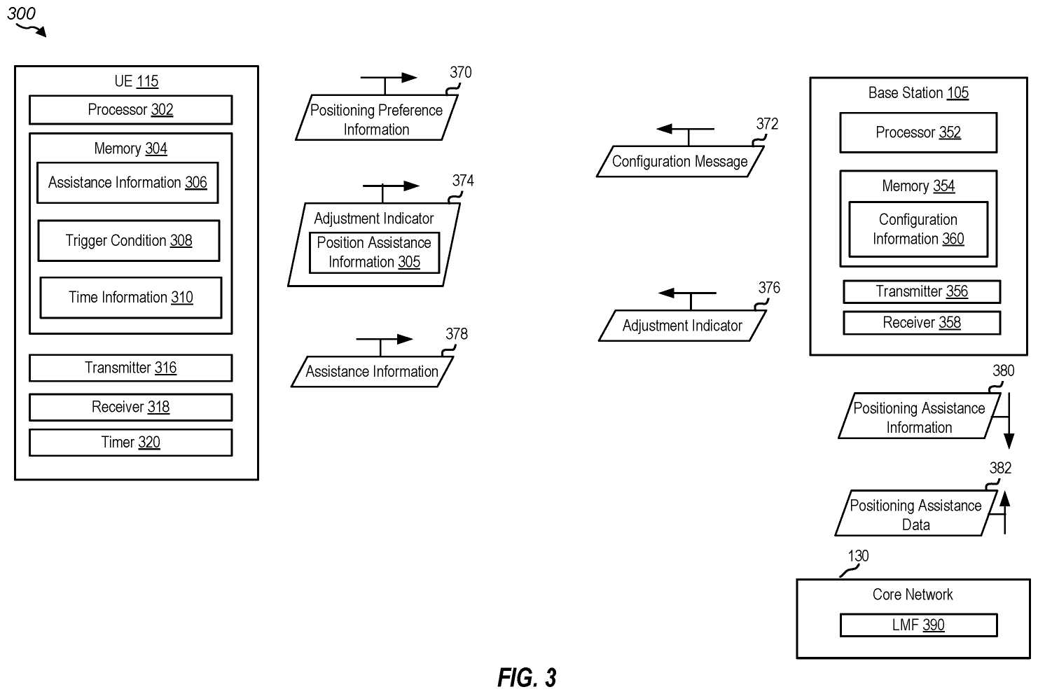

FIG. 3 is a block diagram of an example wireless communications system 300 that supports an assistance indicator that includes position assistance information according to one or more aspects. The assistance indicator may include or correspond to a UAI message. In some examples, wireless communications system 300 may implement aspects of wireless network 100. Wireless communications system 300 includes UE 115, base station 105, and core network 130. Although one UE 115 and one base station 105 are illustrated, in some other implementations, wireless communications system 300 may generally include multiple UEs 115, and may include more than one base station 105.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), one or more receivers 318 (hereinafter referred to collectively as “receiver 318”), and a timer 320. Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store assistance information 306, trigger condition information 308, and time information 310. Assistance information 306 may include or correspond to one or more capabilities of UE 115, such as a position capability or other data processing capability of UE 115, as an illustrative, non-limiting example. In some implementations, assistance information 306 may include or indicate one or more preferences, such as a positioning preference, of UE 115. Trigger condition information 308 may include or correspond to one or more trigger conditions or thresholds. UE 115 may be configured to generate assistance information, such as a UAI message or an adjustment indicator, based on a trigger condition being detected. In some implementations, the trigger conditions may include or be associated with a low power condition, an overheating condition, a dual subscriber identity module (SIM) mode, or a combination thereof, as illustrative, non-limiting examples. Time information 310 may include or indicate a duration of one or more time periods.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2.

Timer 320 is configured to track or determine one or more time periods, such as one or more time periods based on time information 310. For example, timer 320 may determine when an amount of time has lapsed since a particular event, such as transmission or reception of a message.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. In some implementations, processor 352 includes or corresponds to one or more of receive processor 238, transmit processor 220, and controller 240, and memory 354 includes or corresponds to memory 242.

Memory 354 includes or is configured to store configuration information 360. Configuration information may include or indicate a configuration, one or more capabilities, or a combination thereof, of UE 115.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

Core network 130 may include a 4G core network, a 5G core, an evolved packet core (EPC). Core network may be coupled, such as communicatively coupled, to base station 105, UE 115, or both. Core network 130 may include or correspond to LMF 390. Although shown and described as being included in core network 130, LMF 390 may be distinct from core network 130 in some implementations. For example the LMF 390 may include one or more servers, such as multiple distributed servers. LMF 390 may be configured to support various functionality, such as managing support for different location services for one or more UEs. For example, LMF 390 is configured to control the positioning parameters for UEs 115 and the LMF 390 can provide information to the base stations 105 and UE 115 so that action can be taken at UE 115. Base stations 105 may forward location messages to the LMF 390 and may communicate with the LMF 390 via a NR Positioning Protocol A (NRPPa). In some implementations, UE 115 and base station 105 are configured to communicate with the LMF 390 via an Access and Mobility Management Function (AMF).

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

During operation of wireless communications system 300, UE 115 transmits positioning preference information 370 to base station 105. Position preference information 370 may include or correspond to assistance information 306.

Based on or responsive to positioning preference information 370, base station 105 generates a configuration message 372. For example, base station 105 may generate configuration message 372 based on configuration information 360.

In some implementations, base station 105 may send positioning preference information 370 to core network 130, LMF 390, or both. Core network 130 or LMF 390 may respond to the positioning preference information 370 by providing positioning assistance data and base station 105 may generate configuration message 372 based on the positioning assistance data.

UE 115 receives configuration message 372 and configures one or more capabilities of UE 115, such as one or more positioning capabilities, based on configuration message 372. In some implementations, communication between UE 115 and base station 105 in relation to positioning preference information 370, configuration message 372, or a combination thereof, may be associated with an RRC connection establishment procedure or an RRC connection re-establishment procedure.

After configuring UE 115, UE 115 may detect a first trigger condition. The first trigger condition may include or correspond to trigger condition information 308. Based on detection of the first trigger condition, UE 115 generates adjustment indicator 374, position assistance information 305, or a combination thereof. In some implementations, adjustment indicator 374 may include or correspond to a UAI message, such as an RRC UAI message. The adjustment indicator 374 may include position assistance information 305, such as position assistance data. Position assistance information 305 may include or correspond to assistance information 306. Position assistance information 305 may include or indicate one or more settings or options. The one or more options or settings may include a first option to support FR1 or FR2, a second option to increase or reduced positioning frequency layers (PFL), a third option to increase or reduced a positioning reference signal (PRS) bandwidth, a fourth option to increase or reduce a PRS repetition, a fifth option to increase or decrease a carrier specific scaling factor (CSSF), a sixth option to increase or decrease a measurement gap length or gap periodicity, a seventh option to change a positioning method, an eight option to support sidelink (SL) positioning, non-terrestrial network (NTN) positioning, or another positioning method, or any combination thereof of options 1-8. The seventh option to change a positioning method may indicate to change to or from, or be associated with observed tie difference of arrival (OTDOA), time of arrival (TOA), Rx−Tx, or a combination thereof.

In some implementations, adjustment indicator 374 may include one or more information elements. For example, a first information element of the one or more information elements may include position assistance information 305. The first information may include a format of “PositionAssitanceInfo: (Optional)”. The one or more information elements may also include other information elements, such as an information element defined in Rel. 15 or Rel. 16.

In some implementations, adjustment indicator 374 or one or more information elements may be included in UEAssistanceInformation-v1540-IEs. To illustrate, a representative portion of code for UEAssistanceInformation-v1540-IEs may include:

| UEAssistanceInformation-v1540-IEs ::= | SEQUENCE { | |
|---|---|---|
| overheatingAssistance | Overheating Assistance | OPTIONAL, |
| nonCritical Extension | UEAssistanceInformation-v1610-IEs | OPTIONAL |

}

| OverheatingAssistance ::= | SEQUENCE { | |
|---|---|---|
| reducedMaxCCs | ReducedMaxCCs-r16 | OPTIONAL, |
| reducedMaxBW-FR1 | ReducedMaxBW-FRx-r16 | OPTIONAL, |
| reducedMaxBW-FR2 | ReducedMaxBW-FRx-r16 | OPTIONAL, |
| reducedMaxMIMO-LayersFR1 | SEQUENCE { | |
| reducedMIMO-LayersFR1-DL | MIMO-LayersDL, | |

| | |
|---|---|
| reducedMIMO-LayersFR1-UL | MIMO-LayersUL |

} OPTIONAL,

| | |
|---|---|
| reducedMaxMIMO-LayersFR2 | SEQUENCE { |
| reducedMIMO-LayersFR2-DL | MIMO-LayersDL, |
| reducedMIMO-LayersFR2-UL | MIMO-LayersUL |

} OPTIONAL
}

Additionally, or alternatively, adjustment indicator 374 or one or more information elements may be included in UEAssistanceInformation-v1610-IEs. To illustrate, a representative portion of code for UEAssistanceInformation-v11610-IEs may include:

| UEAssistanceInformation-v1610-IEs =:: | SEQUENCE { | |
|---|---|---|
| idc-Assistance-r16 | IDC-Assistance-r16 | OPTIONAL, |
| drx-Preference-r16 | DRX-Preference-r16 | OPTIONAL, |
| maxBW-Preference-r16 | MaxBW-Preference-r16 | OPTIONAL, |
| maxCC-Preference-r16 | MaxCC-Preference-r16 | OPTIONAL, |
| maxMIMO-LayerPreference-r16 | MaxCC-Preference-r16 | OPTIONAL, |

| | |
|---|---|
| minSchedulingOffsetPreference-r16 | minSchedulingOffsetPreference-r16 |

OPTIONAL,

| | | |
|---|---|---|
| releasePreference-r16 | ReleasePreference-r16 | OPTIONAL, |

| | |
|---|---|
| sl-UE-AssistanceInformationNR-r16 | SL-UE-AssistanceInformatinoNR-r16 |

OPTIONAL,

| | | |
|---|---|---|
| referenceTimeInfoPreference-r16 | BOOLEAN | OPTIONAL, |
| nonCriticalExtension | SEQUENCE { } | OPTIONAL |

}

| IDC-Assistance-r16 ::= | SEQUENCE { | |
|---|---|---|
| affectedCarrierFreqList-r16 | AffectedCarrierFreqList-r16 | OPTIONAL, |

| | |
|---|---|
| affectedCarrierFreqCombList-r16 | AffectedCarrierFreqCombList-r16 |

```
      OPTIONAL,
  . . .
}
```

| | |
|---|---|
| AffectedCarrierFreqList-r16 ::= | SEQUENCE (SIZE (1 . . maxFreqIDC-r16)) OF |

AffectedCarrierFreq-r16

| | |
|---|---|
| AffectedCarrierFreq-r16 ::= | SEQUENCE { |
| carrierFreq-r16 | ARFCN-ValueNR, |
| interferenceDirection-r16 | ENUMERATED {nr, other, both, spare} |

}

| | |
|---|---|
| AffectedCarrierFreqCombList-r16 ::= | SEQUENCE (SIZE (1 . . maxCombIDC- |

r16)) OF AffectedCarrierFreqComb-r16

| | |
|---|---|
| AffectedCarrierFreqComb-r16 ::= | SEQUENCE { |
| affectedCarrierFreqComb-r16 | SEQUENCE (SIZE (2 . . |

| | |
|---|---|
| maxNrofServingCells)) OF ARFCN-ValueNR | OPTIONAL, |

| | |
|---|---|
| victimSystemType-r16 | VictimSystemType-r16 |

}

Base station 105 may transmits positioning assistance information 380 to core network 130. Positioning assistance information 380 may include or correspond to position assistance information 305. In some implementations, positioning assistance information 380 transmitted from base station 105 to LMF 390.

After receiving positioning assistance information 380, core network 130 may generate a positioning assistance data 382 and transmit positioning assistance data 382 to base station 105.

Responsive to receiving adjustment indicator 374, base station 105 may generate adjustment indicator 376. In some implementations, base station 105 may generate adjustment indicator 376 based on configuration message 372, configuration information 350, position assistance information 305, adjustment indicator 374, positioning assistance data 382, or a combination thereof. In some implementations, adjustment indicator 376 may include a configuration message, a reconfiguration message, an acknowledgment message, or another message. Base station 105 may transmit adjustment indicator 376 to UE 115.

Responsive to or based on detection of the first trigger condition, UE 115 may perform an adjustment, such as a first adjustment. The first adjustment may adjust a UE capability, such as a positioning capability. In some implementations, the first adjustment is performed after or responsive to receiving adjustment indicator 376. In other implementations, the first adjustment may be performed prior to or independent of adjustment indicator 376 or receipt of adjustment indicator 376.

After the first adjustment, UE 115 may monitor for one or trigger conditions. In the event that UE 115 detects a second trigger condition, UE 115 may generate assistance information 378 and transmit assistance information 378 to base station 105. Assistance information 378 may include or correspond to a UAI message, such as an RRC UAI message. The assistance information 378 may include or correspond to position assistance information, such as position assistance information 305, which may include or indicate one or more settings or options. Based on or responsive to detection of the second trigger, UE 115 may perform a second adjustment to the positioning capabilities of UE 115. Accordingly, based on the detected first trigger condition, such as an overheating condition, UE 115 may adjust the position capability from the first capability state to the second capability state. Based on the detected second trigger condition, such as an overheating condition no longer being present, UE 115 may adjust the position capability back to the first capability state from the second capability state. In some implementations, the second capability state is a reduced capability state as compared to the first capability state.

In some implementations, system 300 is configured to support an IE, such as an optional IE, in a UAI structure to enable reporting of a positioning preference by UE 115. The IE may have the format “PositionAssistanceInfo: (Optional)”. In some implementations, base station 105 may set the IE, such as the optional IE, in an RRC configuration message. In some such implementations, UE 115 may report PositionAssistanceInfo if UE 115 is configured based on the RRC configuration message.

In some implementations, PositionAssistanceInfo may include at least one of the following options:
Option 1: Support of FR1 or FR2 or both;
Option 2: Increase or Reduced PFL;
Option 3: Increase or Reduced PRS bandwidth;
Option 4: Increase or Reduces PRS repetition;
Option 5: Increase or decrease CSSF. (carrier specific scaling factor);
Option 6: Increase or decrease Measurement gap length, Gap periodicity;
Option 7: Changed positioning Methods (OTDOA, TOA, Rx−Tx);
Option 8: Support of SL positioning, NTN positioning or other positioning methods.

In some implementations, base station 105 is configured to forward (e.g., transmit) the PositionAssistanceInfo, such as a PositionAssistanceInfo message to LMF 390. In some such implementations, base station 105 may communicate with, such as transmit the PositionAssistanceInfo message, LMF 390 via NRPPa protocol. LMF 390 may be configured to control and assist base station 105 to inform UE 115 as to which IE's of a plurality of IEs, or one or more options, associated with the PositionAssistanceInfo that UE 115 can fill and report.

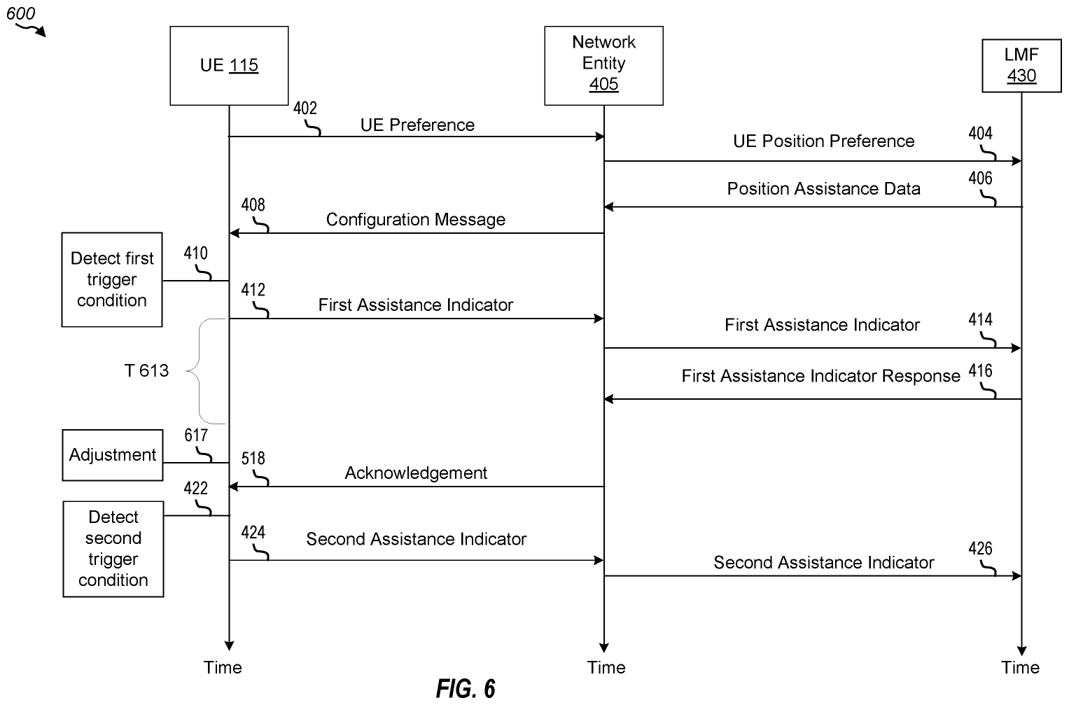

In some implementations, after reporting the PositionAssistanceInfo message to base station 105, core network 130, or LMF 390, UE 115 may voluntarily reduce its positioning capability after a defined time period T. The time period T may include or correspond to time information 310. The time period T may be indicated to UE 115 via LMF signaling or can be determined based on a standard. An example of use of the time period is described further herein with reference to at least FIG. 6.

In some implementations, base station 105, core network 130, or LMF 390 may be configured to change the positioning assistance data (AD) after or based on receiving the PositionAssistanceInfo message from UE 115. In some implementations, the change is persistent such that UE 115 operates at an adjusted or changed capability, such as a lower capability, until positioning session info is subsequently changed or adjusted. The positioning session info may be subsequently changed or adjusted based on positing assistance data received from base station 105, core network 130, or LMF 390. An example of such operations is described further herein with reference to at least FIG. 4.

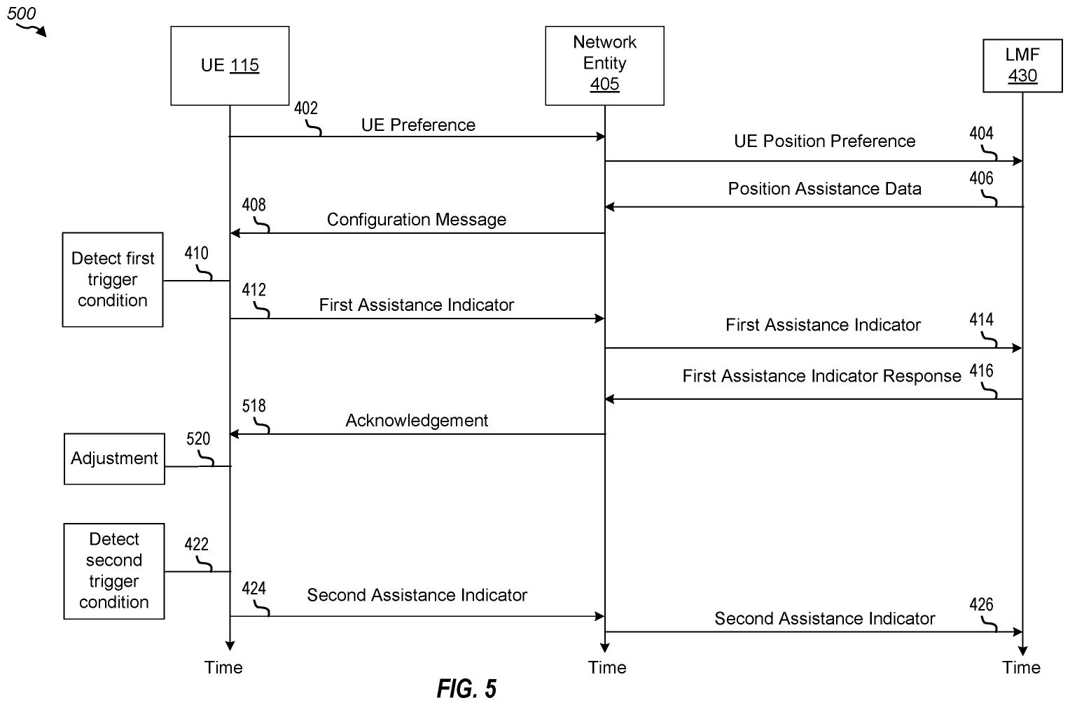

In some implementations, base station 105, core network 130, or LMF 390 may send acknowledgement for UE 115 to temporarily reduce the positioning ability. UE 115 may implement a change or adjustment after receiving the acknowledgment from base station 105, core network 130, or LMF 390. The change or adjustment may be temporary, such that UE 115 may report back to base station 105, core network 130, or LMF 390 that a detected condition has gone away. In some implementations, when the detected condition has gone away, UE 115 can resume prior capability, such as full or preferred capability, autonomously—e.g., without waiting for explicit instruction from base station 105, core network 130, or LMF 390. An example of such operations is described further herein with reference to at least FIG. 5.

As described with reference to FIG. 3, the present disclosure provides techniques that supports an assistance indicator, such as a UAI message, that includes position assistance information. The assistance indicator may enable UE 115 to temporality operate at a reduced capability, such as a reduced positioning capability, based on or in response to a detected trigger condition. Adjusting a positioning capability of UE 115 provide UE 115 with additional flexibility and adjustment options in view of conventional approaches to adjust data processing capabilities of UE 115. Accordingly, the assistance indicator enables UE 115 to have improved operations to dynamically address the detected trigger condition, reduce damage and interruptions, and thereby improve a user experience.

FIGS. 4-6 are ladder diagrams each illustrating examples of assistance indicator signaling that includes position assistance information according to aspects of the present disclosure As shown in FIGS. 4-6, a system of the ladder diagram includes UE 115, a network entity 405, and a LMF 430. Network entity 405 may include or correspond to base station 105 or core network 130. LMF 430 may include or correspond to core network 130 or LMF 390. Although shown and described as being separate, in some implementations, network entity 405 and LMF 430 may be included in the same device, such as a single server or a distributed server system. UE 115, network entity 405, and LMF 430 may include one or more components and be configured to perform one or more operations, as described with reference to FIGS. 1-3.

Referring to FIG. 4, during operation, at 402, UE 115 transmits a UE preference to network entity 405. The UE preference may include or correspond to assistance information 306, positioning preference information 370, or a combination thereof.

At 404, network entity 405 transmits UE position preference to LMF 430. The UE position preference may include or correspond to at least a portion of the UE preference communicated from UE 115 to network entity 405 at 402. For example, the UE position preference may include or correspond to positioning assistance information 380.

Based on the UE position preference, LMF 430 may generate position assistance data and, at 406, LMF 430 transmits position assistance data to network entity 405. The position assistance data may include or correspond to positioning assistance data 382.

Based on the position assistance data, network entity 450 may generate a configuration message and, at 408, network entity 405 transmits the configuration message to UE 115. The configuration message may include or correspond to configuration information 360 or configuration message 372. Although network entity is described as transmitting the UE position preference and receiving the position assistance data, in other implementations, the network entity may not transmit the UE position preference and not receive the position assistance data. In such implementations, network entity 405 may generate the configuration message based on or responsive to receiving the UE preference. UE 115 may receive the configuration message and may configured one or more capabilities of the UE, such as one or more positioning capabilities, based on the configuration message. In some implementations, communication between UE 115 and network entity 405 at 402 and 408 may be associated with an RRC connection establishment procedure or an RRC connection re-establishment procedure.

At 410, UE 115 detects a first trigger condition. The first trigger condition may include or correspond to trigger condition information 308. Based on detection of the first trigger condition, UE 115 generates a first assistance indicator. For example, the first assistance indicator may include or correspond to adjustment indicator 374, position assistance information 305, or a combination thereof.

At 412, UE transmits the first assistance indicator to network entity 405. At 414, network entity 405 transmits the first assistance indicator to LMF 430. In some implementations, the first assistance indicator transmitted from network entity 405 to LMF 430 may include or correspond to positioning assistance information 380.

After receiving the first assistance indicator, LMF 430 may generate a first assistance indicator response. In some implementations, the first assistance indicator response may be generated based on the first assistance indicator. The first assistance indicator response may include or correspond positioning assistance data 382. After receiving the first assistance indicator response, network entity 405 may generate a response message. In some implementations, network entity 405 may generate the response message based on the first assistance indicator response. The response message may include or correspond to adjustment indicator 376. For example, the response message may include a configuration message, a reconfiguration message, an acknowledgment message, or another message.

At 419, UE 115 may perform an adjustment. The adjustment may adjust a UE capability, such as a positioning capability. The UE capability may be adjusted based on or responsive to the detected first trigger condition. In some implementations, the adjustment is performed after or responsive to receiving the response message. In other implementations, the adjustment may be performed prior to or independent of the response message or receipt of the response message.

At 422, UE 115 detects a second trigger condition. The second trigger condition may include or correspond to trigger condition information 308. Based on detection of the second trigger condition, UE 115 generates a second assistance indicator. For example, the second assistance indicator may include or correspond to adjustment indicator 374, position assistance information 305, or a combination thereof.

At 424, UE transmits the second assistance indicator to network entity 405. At 426, network entity 405 transmits the second assistance indicator to LMF 430. In some implementations, the second assistance indicator transmitted from network entity 405 to LMF 430 may include or correspond to positioning assistance information 380.

After receiving the second assistance indicator, LMF 430 may generate a second assistance indicator response. In some implementations, the second assistance indicator response may be generated based on the second assistance indicator. The second assistance indicator response may include or correspond positioning assistance data 382. After receiving the second assistance indicator response, network entity 405 may generate a second response message. In some implementations, network entity 405 may generate the second response message based on the second assistance indicator response. The second response message may include or correspond to adjustment indicator 376. For example, the second response message may include a configuration message, a reconfiguration message, an acknowledgment message, or another message.

After detection of the second trigger condition, UE 115 may perform a second adjustment (not shown). The second adjustment may adjust the UE capability, such as the positioning capability. The UE capability may be adjusted based on or responsive to the detected second trigger condition. In some implementations, the second adjustment is performed after or responsive to receiving the second response message. In other implementations, the second adjustment may be performed prior to or independent of the second response message or receipt of the second response message.

It is noted that one or more operations described with respect to FIG. 4 may not be performed. For example, one or more operations at 422-434 may not be performed. In some implementations, the adjustment at 419 changes a position capability from a first capability state to a second capability state, the second adjustment changes the position capability from the second capability state to the first capability state, or a combination thereof. Accordingly, based on the detected first trigger condition, such as an overheating condition, UE 115 may adjust the position capability from the first capability state to the second capability state. Based on the detected second trigger condition, such as an overheating condition no longer being present, UE 115 may adjust the position capability back to the first capability state from the second capability state.

Thus, FIG. 4 shows that LMF 430 may provide the first assistance indicator response, such as positioning assistance data, after receiving the first assistance indicator from UE 115. This change based on the adjustment at 419 is persistent such that UE 115 may operate at lower positioning capability until additional positioning assistance data is received from LMF 430 by UE 115 to cause UE 115 to adjust its positioning capability. For example, the positing capability may be adjust a second time back to the same positioning capability that was implement prior to or during detection of the first trigger condition.

Referring to FIG. 5, one or more operations of FIG. 5 may be the same as described with reference to FIG. 4. As compared to FIG. 4, network entity 405, at 416, may receive the first assistance indicator response from LMF 430, and may generate an acknowledgment based on the first assistance indicator response. In some implementations, the first assistance indictor response may include an acknowledgement. At 518, network entity 405 transmits the acknowledgement to UE 115. The acknowledgement may include or correspond to the adjustment indicator 376.

At 520, after receiving the acknowledgement, UE 115 may perform an adjustment. The adjustment may adjust a UE capability, such as a positioning capability. The UE capability may be adjusted based on or responsive to the detected first trigger condition. In some implementations, the adjustment is performed after or responsive to receiving the acknowledgement.

In some implementations, if UE 115 does not receive the acknowledgement that is responsive to the first assistance indicator, UE 115 may retransmit the first assistance indictor. For example, if the acknowledgement is not received within a first amount of time after transmission of the first assistance indictor, UE 115 may retransmit the first assistance indicator in an effort to receive the acknowledgement. Alternatively, if UE 115 does not receive the acknowledgement that is responsive to the first assistance indicator, UE 115 may transmit an assistance indictor that indicates that UE 115 will perform an adjustment after a time period T independent of whether or not UE 115 receives an acknowledgment based on the first assistance indicator or based on the assistance indictor that indicates that UE 115 will perform an adjustment after a time period T. Performance of an adjust after a time period T is described herein at least with reference to FIG. 6. The time period T may include or correspond to time information 310.

After the adjustment at 520, operation continues as described with reference to FIG. 4. Accordingly, FIG. 5 shows that LMF 430 may send an acknowledgement for UE 115 to make the adjustment. The change that results from the adjustment may be temporary, such that UE 115 may report back to LMF 430 when a condition is resolved, such as overheating no longer being present. To illustrate, after receiving the acknowledgement, at 518, and performing the adjustment, at 520, UE may perform a second adjustment based on the detected second trigger condition and the second adjustment may be performed independent of any communication or signaling from UE 115 to network entity 405 or LMF 430.

Referring to FIG. 6, one or more operations of FIG. 5 may be the same as described with reference to FIG. 4 or 5. As compared to FIGS. 4 and 5, UE 115 waits a time period T 613 to perform an adjustment at 617 after transmission of the first assistance indicator at 412. UE 115 may use a time, such as timer 230, to identify when a time period T has expired. The time period T may be determined based on a standard or determined by UE 115, such as based on one or more system conditions or a severity of the detected trigger condition. The adjustment at 520 may include or correspond to the adjust 419 of FIG. 4 or the adjustment 520 of FIG. 5. In some implementations, the first assistance indicator may include an indicator associated with the time period T.

At 617, UE 115 performs the adjustment. The adjustment at 617 may be performed by UE 115 independent of receipt of the acknowledgment at 418. According, the acknowledgment may be received by UE 115 prior or subsequent to the adjustment at 617. Thus, FIG. 6 shows that after reporting the first assistance indicator to network entity 405 or LMF 430, UE 115 voluntarily adjusts, such as reduces, its positioning capability after a time period T.

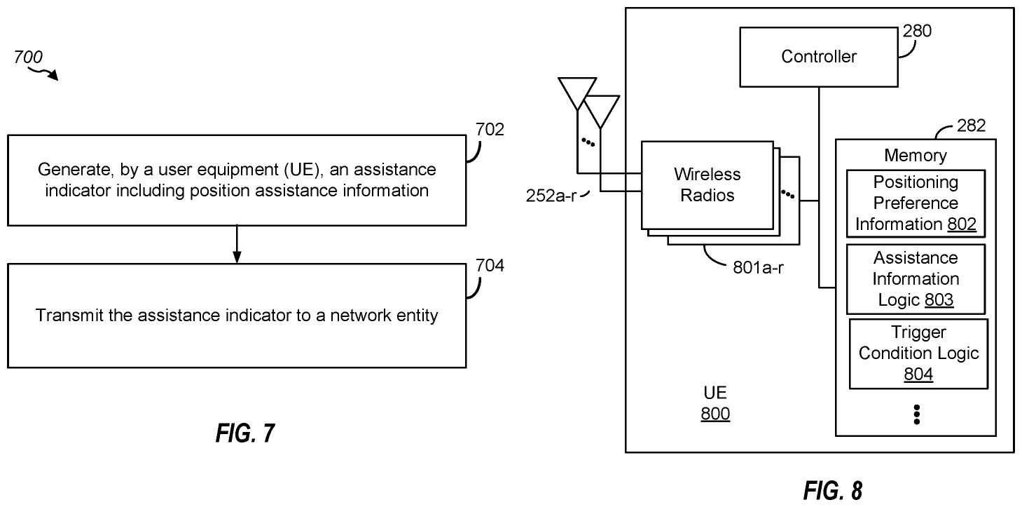

FIG. 7 is a flow diagram illustrating an example process 700 that supports an assistance indicator, such as a UAI message, that includes position assistance information according to one or more aspects. Operations of process 700 may be performed by a UE, such as UE 115 described above with reference to FIGS. 1-6, or a UE described with reference to FIG. 8. For example, example operations (also referred to as “blocks”) of process 700 may enable UE 115 to support an assistance indicator, such as a UAI message, that includes position assistance information.

In block 702, the UE generates an assistance indicator including position assistance information. The position assistance information may be associated with a request to a change in a UE position preference associated with a UE capability, such as a positioning capability. The position assistance information may include or correspond to assistance information 306, position assistance information 305, adjustment indicator 374, or a combination thereof. In some implementations, the assistance indicator includes a UE assistance indicator (UAI). Additionally, or alternatively, the position assistance information includes an information element that includes the position assistance information. The position assistance information may indicate to support FR1 or FR2, increase or reduced positioning frequency layers (PFL), increase or reduced a positioning reference signal (PRS) bandwidth, increase or reduce a PRS repetition, increase or decrease a carrier specific scaling factor (CSSF), increase or decrease a measurement gap length or gap periodicity, change a positioning method, or support sidelink (SL) positioning, non-terrestrial network (NTN) positioning, or another positioning method.

In block 704, the UE transmits the assistance indicator to a network entity. The network entity may include or correspond to base station 105, core network 130, LMF 390, network entity 405, or LMF 430. The assistance indicator may be generated, transmitted, or both, while the UE is an RRC connected state with the network entity. Additionally, or alternatively, in some implementations, the network entity may include a base station configured to forward the position assistance information to a LMF. In some such implementations, the base station is configured to communicate with the LMF via a NRPPa.

In some implementations, the UE may transmit a message including positioning preference information to the network entity. The message may include or correspond to assistance information 306, positioning preference information 370, or a combination thereof. The positioning preference information and the position assistance information may be associated with the same capability of the one or more capabilities of the UE, such as a positioning capability of the UE. The message may be transmitted prior to generation or transmission of the assistance indicator. Additionally, or alternatively, the UE may receive a configuration message from the network entity. For example, the configuration message may include or correspond to configuration message 372, configuration information 360, positioning assistance data 382, or a combination thereof. The configuration message includes a radio resource control (RRC) configuration message. In some implementations, the configuration message may include configuration information. The configuration information may indicate one or more IEs of a plurality of position assistance information IEs that the LMF indicated as usable by the UE. The UE may configure one or more capabilities, such as a positioning capability, of the UE based on the configuration information. Receipt of the configuration message, configuration of the one or more capabilities, or both may occur prior to prior to generation or transmission of the assistance indicator.

In some implementations, after transmission of the assistance indicator, the UE performs an adjustment on a position capability of the UE. For example, the UE may determine that an amount of time after transmission of the assistance indicator has lapsed. The UE may perform the adjustment performed based on a determination that the amount of time after the transmission of the assistance indicator has lapsed. As another example, the UE may receive, from the network entity, an adjustment indicator responsive to the position assistance information. The UE may perform the adjustment based on or responsive to the adjustment indicator. The adjustment indicator may include or correspond to adjustment indicator 376, positioning assistance data 382, or a combination thereof. In some implementations, the adjustment indicator includes position assistance data or an acknowledgement message associated with the adjustment.

In some implementations, the UE detects a first trigger condition. For example, the first trigger condition may be associated with a low power condition, an overheating condition, a dual subscriber identity module (SIM) mode, or a combination thereof. The position assistance information may be generated based on detection of the first trigger condition. Additionally, or alternatively, after the adjustment of the position capability of the UE, the UE may detect a second trigger condition. The first trigger condition, the second trigger condition, or both, may include or correspond to trigger condition information 308.

In some implementations, the UE may generate a second assistance indicator including second position assistance information. The second assistance indicator may be generated based on the detected second trigger condition. The second assistance indicator may include or correspond to the assistance information 378. The UE may transmit the second assistance indicator to the network entity. The UE 115 may receive, from the network entity, a second adjustment indicator responsive to the second position assistance information. Additionally, or alternatively, the UE 115 may perform a second adjustment on the position capability of the UE. The second adjustment may be associated with the detected second trigger condition, the second adjustment indicator, or a combination thereof. In some implementations, the adjustment changes the position capability from a first capability state to a second capability state, the second adjustment changes the position capability from the second capability state to the first capability state, or a combination thereof.

FIG. 8 is a block diagram of an example UE 800 that supports an assistance indicator, such as a UAI message, that includes position assistance information to one or more aspects. UE 800 may be configured to perform operations, including the blocks or operations of a process described with reference to FIGS. 4-7. In some implementations, UE 800 includes the structure, hardware, and components shown and described with reference to UE 115 of FIGS. 1-3. For example, UE 800 includes controller 280, which operates to execute logic or computer instructions stored in memory 282, as well as controlling the components of UE 800 that provide the features and functionality of UE 800. UE 800, under control of controller 280, transmits and receives signals via wireless radios 801a-r and antennas 252a-r. Wireless radios 801a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include positioning preference information 802, assistance information logic 803, and trigger condition logic 804. Positioning preference information 802 may include or correspond to assistance information 306, positioning preference information 370, or a combination thereof. Assistance information logic 803 may be configured to identify or determine assistance information, such as assistance information 306, generate positioning preference information, such as positioning preference information 370, generate an adjustment indicator, such as adjustment indicator 374, or a combination thereof. Additionally, or alternatively, assistance information logic 803 is configured to generate an assistance indicator including position assistance information. In some implementations, Trigger condition logic 804 may be configured to detect a trigger condition, such as a trigger condition associated with trigger condition information 308. UE 500 may receive signals from or transmit signals to one or more network entities, such as base station 105, core network 130, LMF 390, network entity 405, LMF 430 or a base station as illustrated in FIG. 10. The wireless radios 801a-r may be configured to transmit the assistance indicator to a network entity.

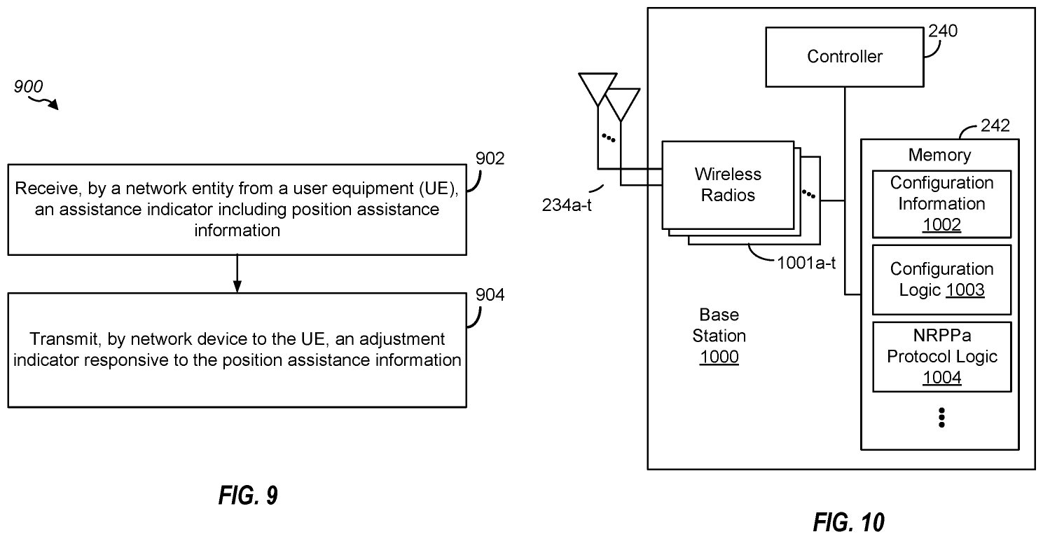

FIG. 9 is a flow diagram illustrating an example process 900 that supports an assistance indicator, such as a UAI message, that includes position assistance information according to one or more aspects. Operations of process 900 may be performed by a network entity. The network entity may include or correspond to network entity 405 of FIGS. 4-6 or a base station, such as base station 105 described above with reference to FIGS. 1-3 or a base station as described above with reference to FIG. 10. In some implementations, the network entity may include or correspond to base station 105, core network 130, LMF 390, network entity 405, or LMF 430. For example, example operations of process 900 may enable base station 105 to support an assistance indicator, such as a UAI message, that includes position assistance information.

At block 902, the network entity receives, from a UE, an assistance indicator including position assistance information. The UE may include or correspond to UE 115. The position assistance information may be associated with a request to a change in a UE position preference associated with a UE capability, such as a positioning capability. The position assistance information may include or correspond to assistance information 306, position assistance information 305, adjustment indicator 374, or a combination thereof. In some implementations, the assistance indicator includes a UE assistance indicator (UAI). Additionally, or alternatively, the position assistance information includes an information element that includes the position assistance information. The position assistance information may indicate to support FR1 or FR2, increase or reduced positioning frequency layers (PFL), increase or reduced a positioning reference signal (PRS) bandwidth, increase or reduce a PRS repetition, increase or decrease a carrier specific scaling factor (CSSF), increase or decrease a measurement gap length or gap periodicity, change a positioning method, or support sidelink (SL) positioning, non-terrestrial network (NTN) positioning, or another positioning method. The assistance indicator may be received while the UE is an RRC connected state with the network entity. Additionally, or alternatively, in some implementations, the network entity may include a base station configured to forward the position assistance information to a LMF. In some such implementations, the base station is configured to communicate with the LMF via a NRPPa.

At block 904, the network entity transmits, to the UE, an adjustment indicator responsive to the position assistance information. The adjustment indicator may include or correspond to adjustment indicator 376, positioning assistance data 382, or a combination thereof. In some implementations, the adjustment indicator includes position assistance data or an acknowledgement message associated with the adjustment. After transmission of the assistance indicator, the UE may perform an adjustment on a position capability of the UE. In some implementations, the UE may perform the adjustment on the position capability of the UE independent of the assistance indicator.

In some implementations, the network entity may receive, from the UE, a message including positioning preference information to the network entity. The message may include or correspond to assistance information 306, positioning preference information 370, or a combination thereof. The positioning preference information and the position assistance information may be associated with the same capability of the one or more capabilities of the UE, such as a positioning capability of the UE. The message may be received prior to receipt of the assistance indicator. Additionally, or alternatively, the network entity may generate, transmit, or both, a configuration message to the UE. For example, the configuration message may include or correspond to configuration message 372, configuration information 360, positioning assistance data 382, or a combination thereof. The configuration message includes a radio resource control (RRC) configuration message. In some implementations, the configuration message may include configuration information. The configuration information may indicate one or more IEs of a plurality of position assistance information IEs that the LMF indicated as usable by the UE. The UE may configure one or more capabilities, such as a positioning capability, of the UE based on the configuration information.

In some implementations, the network entity may receive a second assistance indicator from the UE. The network entity may transmit, to the UE, a second adjustment indicator responsive to the second position assistance information. The UE may perform a second adjustment in association with the second assistance indicator, the second adjustment indicator, or a combination thereof.

FIG. 10 is a block diagram of an example base station 1000 that supports an assistance indicator, such as a UAI message, that includes position assistance information according to one or more aspects. Base station 1000 may be configured to perform operations, including the blocks or operations of a process described with reference to FIGS. 4-6 and 9. In some implementations, base station 1000 includes the structure, hardware, and components shown and described with reference to base station 105 of FIGS. 1-3. For example, base station 1000 may include controller 240, which operates to execute logic or computer instructions stored in memory 242, as well as controlling the components of base station 1000 that provide the features and functionality of base station 1000. Base station 1000, under control of controller 240, transmits and receives signals via wireless radios 1001a-t and antennas 734a-t. Wireless radios 1001a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include configuration information 1002, configuration logic 1003, and NRPPa protocol logic 1004. Configuration information 1002 may include or correspond to configuration information 360 or configuration message 372. Configuration logic 703 may be configured to generate a configuration message, such as configuration message 372. NRPPa protocol logic 1004 may be configured to generate one or more message to communicate between base station 1000 and an LMF. Base station 1000 may receive signals from or transmit signals to one or more UEs, such as UE 115 of FIGS. 1-3 or UE 800 of FIG. 8. Wireless radios 1001a-t may be configured to receive, from a UE, an assistance indicator including position assistance information, and to transmit, to the UE, an adjustment indicator responsive to the position assistance information.

It is noted that one or more blocks (or operations) described with reference to FIG. 7 or 9 may be combined with one or more blocks (or operations) described with reference to another of the figures. For example, one or more blocks (or operations) of FIG. 7 may be combined with one or more blocks (or operations) of FIG. 4-6 or 9. As another example, one or more blocks associated with FIG. 9 may be combined with one or more blocks associated with FIG. 4-6 or 10. As another example, one or more blocks associated with FIG. 7 or 9 may be combined with one or more blocks (or operations) associated with FIGS. 1-6. Additionally, or alternatively, one or more operations described above with reference to FIGS. 1-3 may be combined with one or more operations described with reference to FIG. 8 or 10.

In one or more aspects, techniques for supporting an assistance indicator, such as a UAI message, that includes position assistance information may include additional aspects, such as any single aspect or any combination of aspects described below or in connection with one or more other processes or devices described elsewhere herein. In a first aspect, supporting an assistance indicator, such as a UAI message, that includes position assistance information may include an apparatus configured to generate an assistance indicator including position assistance information. The apparatus is further configured to transmit the assistance indicator to a network entity. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the assistance indicator includes a UAI, the position assistance information includes an information element that includes the position assistance information, or a combination thereof.

In a third aspect, in combination with one or more of the first aspect or the second aspect, the position assistance information indicates to: support FR1 or FR2; increase or reduced PFL; increase or reduced a PRS bandwidth; increase or reduce a PRS repetition; increase or decrease a CSSF; increase or decrease a measurement gap length or gap periodicity; change a positioning method; support SL positioning, NTN positioning, or another positioning method; or a combination thereof.

In a fourth aspect, in combination with one or more of the first aspect through the third aspect, the apparatus is further configured to transmit, to the network entity, a message including positioning preference information.

In a fifth aspect, in combination with the fourth aspect, the apparatus is further configured to receive, from the network entity, a configuration message including configuration information.

In a sixth aspect, in combination with the fifth aspect, the apparatus is further configured to configure one or more capabilities of the UE based on the configuration information.

In a seventh aspect, in combination with the sixth aspect, the network entity includes a base station configured to forward the position assistance information to a LMF.

In an eighth aspect, in combination with the seventh aspect, the base station is configured to communicate with the LMF via an NRPPa protocol.

In a ninth aspect, in combination with one or more of the sixth aspect through the eighth aspect, the configuration information indicates one or more IEs of a plurality of position assistance information IEs that the LMF indicated as usable by the apparatus.

In a tenth aspect, in combination with the sixth aspect, the configuration message includes an RRC configuration message.

In an eleventh aspect, in combination with one or more of the sixth aspect or the tenth aspect, the positioning preference information and the position assistance information are associated with the same capability of the one or more capabilities of the apparatus.

In a twelfth aspect, in combination with one or more of the first aspect through the eleventh aspect, the apparatus is further configured to, after transmission of the assistance indicator, perform an adjustment on a position capability of the apparatus.

In a thirteenth aspect, in combination with the twelfth aspect, the apparatus is further configured to determine that an amount of time after transmission of the assistance indicator has lapsed, the adjustment performed based on a determination that the amount of time after the transmission of the assistance indicator has lapsed.

In a fourteenth aspect, in combination with the twelfth aspect, the apparatus is further configured to receive, from the network entity, an adjustment indicator responsive to the position assistance information.

In a fifteenth aspect, in combination with the fourteenth aspect, the apparatus performs the adjustment based on the adjustment indicator.

In a sixteenth aspect, in combination with the fifteenth aspect, the adjustment indicator includes position assistance data or an acknowledgement message associated with the adjustment.

In a seventeenth aspect, in combination with the twelfth aspect, the apparatus is further configured to detect a first trigger condition, wherein the position assistance information is generated based on detection of the first trigger condition.

In an eighteenth aspect, in combination with the seventeenth aspect, the apparatus is further configured to, after the adjustment of the position capability of the apparatus, detect a second trigger condition.

In a nineteenth aspect, in combination with the eighteenth aspect, the apparatus is further configured to generate a second assistance indicator including second position assistance information.

In a twentieth aspect, in combination with the nineteenth aspect, the apparatus is further configured to transmit the second assistance indicator to the network entity.

In a twenty-first aspect, in combination with the twentieth aspect, the apparatus is further configured to receive, from the network entity, a second adjustment indicator responsive to the second position assistance information.

In a twenty-second aspect, in combination with the twenty-first aspect, the apparatus is further configured to perform a second adjustment on the position capability of the apparatus, the second adjustment associated with the second adjustment indicator.

In a twenty-third aspect, in combination with the twenty-second aspect, the adjustment changes the position capability from a first capability state to a second capability state, the second adjustment changes the position capability from the second capability state to the first capability state, or a combination thereof.

In a twenty-fourth aspect, in combination with one or more of the first aspect through the twenty-third aspect, the first trigger condition is associated with a low power condition, an overheating condition, a dual subscriber identity module (SIM) mode, or a combination thereof.

In a twenty-fifth aspect, in combination with the first aspect, the position assistance information is associated with a request to a change in a UE position preference associated with a UE capability of the apparatus.

In a twenty-sixth aspect, in combination with the first aspect, the network entity includes a base station, a core network, or a LMF.

In a twenty-sixth aspect, in combination with the first aspect, the assistance indicator is generated, transmitted, or both, while the apparatus is an RRC connected state with the network entity.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
generating, by a UE, an assistance indicator including position assistance information; and
transmitting the assistance indicator to a network entity.

2. The method of claim 1, wherein:
the assistance indicator includes a UE assistance indicator (UAI);
the position assistance information includes an information element that includes the position assistance information; or
a combination thereof.

3. The method of claim 1, wherein the position assistance information indicates to:
support FR1 or FR2;
increase or reduced positioning frequency layers (PFL);
increase or reduced a positioning reference signal (PRS) bandwidth;
increase or reduce a PRS repetition;
increase or decrease a carrier specific scaling factor (CSSF);
increase or decrease a measurement gap length or gap periodicity;
change a positioning method;
support sidelink (SL) positioning, non-terrestrial network (NTN) positioning, or another positioning method; or
a combination thereof.

4. The method of claim 1, further comprising:
transmitting, from the UE to the network entity, a message including positioning preference information;
receiving, by the UE from the network entity, a configuration message including configuration information; and
configuring one or more capabilities of the UE based on the configuration information.

5. The method of claim 4, wherein:
the network entity includes a base station configured to forward the position assistance information to a location management function (LMF), the base station is configured to communicate with the LMF via a new radio (NR) positioning protocol A (NRPPa) protocol;
the configuration information indicates one or more information elements (IEs) of a plurality of position assistance information IEs that the LMF indicated as usable by the UE; or
a combination thereof.

6. The method of claim 4, wherein:
the configuration message includes a radio resource control (RRC) configuration message;
the positioning preference information and the position assistance information are associated with the same capability of the one or more capabilities of the UE; or
a combination thereof.

7. The method of claim 1, further comprising, after transmission of the assistance indicator, performing an adjustment on a position capability of the UE.

8. The method of claim 7, further comprising determining that an amount of time after transmission of the assistance indicator has lapsed, the adjustment performed based on a determination that the amount of time after the transmission of the assistance indicator has lapsed.

9. The method of claim 7, further comprising
receiving, by the UE from the network entity, an adjustment indicator responsive to the position assistance information,
wherein the UE performs the adjustment based on the adjustment indicator, and
wherein the adjustment indicator includes position assistance data or an acknowledgement message associated with the adjustment.

10. The method of claim 7, further comprising:
detecting a first trigger condition, wherein the position assistance information is generated based on detection of the first trigger condition;
after the adjustment of the position capability of the UE, detecting a second trigger condition;
generating a second assistance indicator including second position assistance information;
transmitting the second assistance indicator to the network entity;
receiving, by the UE from the network entity, a second adjustment indicator responsive to the second position assistance information; and
performing a second adjustment on the position capability of the UE, the second adjustment associated with the second adjustment indicator, and
wherein the adjustment changes the position capability from a first capability state to a second capability state, the second adjustment changes the position capability from the second capability state to the first capability state, or a combination thereof.

11. A user equipment (UE) comprising:
a memory storing processor-readable code; and
at least one processor coupled to the memory, the at least one processor configured to execute the processor-readable code to cause the at least one processor to:
generate an assistance indicator including position assistance information; and
initiate transmission of the assistance indicator to a network entity.

12. The UE of claim 11, wherein:
the assistance indicator includes a UE assistance indicator (UAI);
the position assistance information includes an information element that includes the position assistance information; or
a combination thereof.

13. The UE of claim 11, wherein the at least one processor is further configured to execute the processor-readable code to cause the at least one processor to:
initiate transmission, from the UE to the network entity, of a message including positioning preference information;
receive, by the UE from the network entity, a configuration message including configuration information; and
configure one or more capabilities of the UE based on the configuration information, and
wherein:
the configuration message includes a radio resource control (RRC) configuration message;
the positioning preference information and the position assistance information are associated with the same capability of the one or more capabilities of the UE; or
a combination thereof.

14. The UE of claim 11, wherein the at least one processor is further configured to execute the processor-readable code to cause the at least one processor to, after transmission of the assistance indicator, perform an adjustment on a position capability of the UE.

15. The UE of claim 14, wherein the at least one processor is further configured to execute the processor-readable code to cause the at least one processor to determine that an amount of time after transmission of the assistance indicator has lapsed, the adjustment performed based on a determination that the amount of time after the transmission of the assistance indicator has lapsed.

16. The UE of claim 14, wherein the at least one processor is further configured to execute the processor-readable code to cause the at least one processor to:
receive, by the UE from the network entity, an adjustment indicator responsive to the position assistance information,
wherein the UE performs the adjustment based on the adjustment indicator, and
wherein the adjustment indicator includes position assistance data or an acknowledgement message associated with the adjustment.

17. The UE of claim 14, wherein the at least one processor is further configured to execute the processor-readable code to cause the at least one processor to:
detect a first trigger condition, wherein the position assistance information is generated based on detection of the first trigger condition;
after the adjustment of the position capability of the UE, detect a second trigger condition;
generate a second assistance indicator including second position assistance information;
initiate transmission of the second assistance indicator to the network entity;
receive, by the UE from the network entity, a second adjustment indicator responsive to the second position assistance information; and
perform a second adjustment on the position capability of the UE, the second adjustment associated with the second adjustment indicator, and
wherein the adjustment changes the position capability from a first capability state to a second capability state, the second adjustment changes the position capability from the second capability state to the first capability state, or a combination thereof.

18. An apparatus configured for wireless communication, the apparatus comprising:
means for generating an assistance indicator including position assistance information; and
means for transmitting the assistance indicator to a network entity.

19. The apparatus of claim 18, further comprising:
means for transmitting, to the network entity, a message including positioning preference information;
means for receiving, from the network entity, a configuration message including configuration information; and
means for configuring, based on the configuration information, one or more user equipment (UE) capabilities, and
wherein:
the configuration message includes a radio resource control (RRC) configuration message;
the positioning preference information and the position assistance information are associated with the same capability of the one or more UE capabilities; or
a combination thereof.

20. The apparatus of claim 18, further comprising means for, after transmission of the assistance indicator, performing an adjustment on a position capability.

21. The apparatus of claim 20, further comprising means for determining that an amount of time after transmission of the assistance indicator has lapsed, the adjustment performed based on a determination that the amount of time after the transmission of the assistance indicator has lapsed.

22. The apparatus of claim 20, further comprising
means for receiving, from the network entity, an adjustment indicator responsive to the position assistance information,
wherein the adjustment is performed based on the adjustment indicator, and
wherein the adjustment indicator includes position assistance data or an acknowledgement message associated with the adjustment.

23. The apparatus of claim 20, further comprising:
means for detecting a first trigger condition, wherein the position assistance information is generated based on detection of the first trigger condition;
means for detecting a second trigger condition after the adjustment of the position capability;
means for generating a second assistance indicator including second position assistance information; and
means for transmitting the second assistance indicator to the network entity.

24. The apparatus of claim 23, further comprising:
means for receiving, from the network entity, a second adjustment indicator responsive to the second position assistance information; and
means for performing a second adjustment on the position capability, the second adjustment associated with the second adjustment indicator.

25. A non-transitory computer-readable medium storing instructions that, when executed by a processor, cause the processor to perform operations comprising:
generating an assistance indicator including position assistance information; and
initiating transmission of the assistance indicator to a network entity.

26. The non-transitory computer-readable medium of claim 25, wherein the operations further include:
initiating transmission, to the network entity, of a message including positioning preference information; an
receiving, from the network entity, a configuration message including configuration information; and
configuring one or more user equipment (UE) capabilities based on the configuration information, and
wherein:
the configuration message includes a radio resource control (RRC) configuration message;
the positioning preference information and the position assistance information are associated with the same capability of the one or more UE capabilities; or
a combination thereof.

27. The non-transitory computer-readable medium of claim 25, wherein the operations further include, after transmission of the assistance indicator, performing an adjustment on a position capability.

28. The non-transitory computer-readable medium of claim 27, wherein the operations further include determining that an amount of time after transmission of the assistance indicator has lapsed, the adjustment performed based on a determination that the amount of time after the transmission of the assistance indicator has lapsed.

29. The non-transitory computer-readable medium of claim 27, wherein the operations further include
receiving, from the network entity, an adjustment indicator responsive to the position assistance information,
wherein the adjustment is performed based on the adjustment indicator, and
wherein the adjustment indicator includes position assistance data or an acknowledgement message associated with the adjustment.

30. The non-transitory computer-readable medium of claim 27, wherein the operations further include:
detecting a first trigger condition, wherein the position assistance information is generated based on detection of the first trigger condition;
after the adjustment of the position capability, detecting a second trigger condition;
generating a second assistance indicator including second position assistance information; and
initiating transmission of the second assistance indicator to the network entity.
